(19) United States
(12) Patent Application Publication
(10) Pub. No.: US 2020/0378615 A1
(43) Pub. Date: Dec. 3, 2020

(54) SUPPLEMENTARY RADIANT HEAT FOR PELLET COOKING APPLIANCES

(71) Applicant: W.C. BRADLEY CO., Columbus, GA (US)

(72) Inventor: Alex Gafford, Midland, GA (US)

(21) Appl. No.: 16/889,237

(22) Filed: Jun. 1, 2020

Related U.S. Application Data
(60) Provisional application No. 62/855,546, filed on May 31, 2019.

(51) Int. Cl. F24C 15/16; A47J 37/07

(52) U.S. Cl. CPC F24C 15/16; A47J 37/0786; A47J 37/0709

(57) ABSTRACT

A cooking apparatus has a cooking chamber, a cooking grate in the cooking chamber, and a combustion chamber within the cooking chamber below the cooking grate. The apparatus includes an electric heating element below the cooking grate, and a baffle interposing the cooking grate and the combustion chamber.

### CROSS-REFERENCE TO RELATED CASES

This application claims the benefit of U.S. provisional patent application Ser. No. 62/855,546, filed on May 31, 2019, and incorporates such provisional application by reference into this disclosure as if fully set out at this point.

### FIELD OF THE INVENTION

The invention relates to pellet cooking appliances. More particularly, the invention relates to a pellet cooking appliance with supplemental radiant heat.

### BACKGROUND OF THE INVENTION

Wood pellet grills have become popular for outdoor cooking and smoking operations. These devices may use an internal firepot within a larger firebox for generating heat and smoke. Fuel may be fed into the firepot via auger to control cooking operations. The firepot presents a much smaller area than the associated cooking grate, however. Such a single point heat source presents difficulties in obtaining even heat distribution over entire an entire cooking area.

What is needed is a system and method for addressing the above and related problems.

### SUMMARY OF THE INVENTION

The invention of the present disclosure, in one aspect thereof, comprises a cooking apparatus having a cooking chamber, a cooking grate in the cooking chamber, and a combustion chamber within the cooking chamber below the cooking grate. The apparatus includes an electric heating element below the cooking grate, and a baffle interposing the cooking grate and the combustion chamber.

In some embodiments, the electric heating element is a resistive heating element. The electric heating element may interpose the baffle and the cooking grate. In some cases it occupies a heating element plane that is parallel to a cooking grate plane occupied by the cooking grate. The baffle may occupy a baffle pane that is parallel to the cooking grate plane. The combustion chamber may comprise a cylindrical firepot configured to burn pelletized solid fuel.

In some configurations, the electric heating element is about 25 mm to about 100 mm below the cooking grate. The electric heating element comprises a loop of resistive material. It may comprise a length of resistive material arranged to have a plurality of parallel segments. There may be at least four parallel segments. In some cases the electric heating element comprises a plurality of separately activatable resistive heating elements.

The invention of the present disclosure, in another aspect thereof, comprises a cooking device having a cooking chamber, a fuel pellet hopper outside the cooking chamber, a cooking grate in the cooking chamber, and a perforated combustion chamber in the cooking chamber below the cooking grate. The system has an auger that transports fuel pellets from the hopper to the combustion chamber, a plenum that delivers combustion air under positive pressure to an area surrounding the combustion chamber and into the combustion chamber, a baffle plate above the combustion chamber, and an electric heating element between the baffle plate and the cooking grate.

The electric heating element may comprise a current carrying metal alloy wire surrounded by an insulating material that is thermally conductive but not electrically conductive, and an outer metal alloy sheath heated by resistive heating of the current carrying metal alloy wire. The electric heating element may be configured in a loop located proximate walls that define a perimeter of said cooking chamber. The electric heating element may comprise a plurality of parallel segments.

The cooking grate, the electric heating element, and the baffle plate may be arranged on parallel planes. The heating element may be from about 25 mm to about 100 mm away from the cooking grate.

The invention of the present disclosure, in another aspect thereof, comprises a method including providing a firebox with a cooking grate therein, providing a solid fuel burning combustion chamber below the cooking grate, and proving a baffle plate between the combustion chamber and the cooking grate that disperses combustion gases from the combustion chamber before the combustion gases reach the cooking grate. A resistive heating element is provided above the baffle plate and provides additional heating to the cooking grate in addition to that from the combustion gases.

The method may include controlling combustion in the combustion chamber by controlled feeding of solid fuel pellets into the combustion chamber, and controlling heating from the resistive heating element by controlled application of electrical current thereto. The method may include arranging the resistive heating element into a series of loops and parallel segments, each equidistant from the cooking grate.

### BRIEF DESCRIPTION OF THE DRAWINGS

FIG. 1 is a perspective view of a pellet grill according to aspects of the present disclosure.

FIG. 2 is a frontal cutaway perspective view of a pellet grill according to aspects of the present disclosure.

FIG. 3 is a side cutaway perspective view of a pellet grill according to aspects of the present disclosure.

FIG. 4 is an overhead cutaway view of a firebox of a pellet grill according to aspects of the present disclosure.

FIG. 5 is an overhead cutaway perspective view of a firebox of another pellet grill according to aspects of the present disclosure.

FIG. 6 is an exploded perspective view of an interior of a firebox of a pellet grill according to aspects of the present disclosure.

FIG. 7 is a closeup cutaway view of a heating element according to aspects of the present disclosure.

### DETAILED DESCRIPTION OF THE PREFERRED EMBODIMENTS

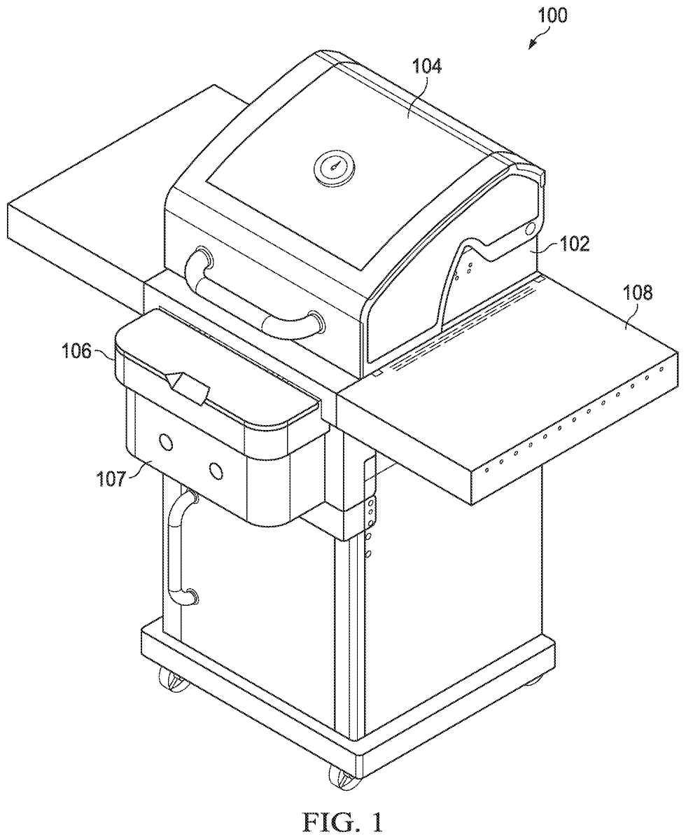

Referring now to FIG. 1, a perspective view of a cooking grill according to aspects of the present disclosure is shown. From the exterior, the grill 100 can be seen to comprise a firebox 102 with an openable lid 104, together defining a cooking chamber. The lid 104 may be hinged from the back and have a handle for opening and closing. Side shelves 108 and other helpful implements may be provided in various embodiments. A front pellet feeding hopper system 106 can be seen where the user feeds fuel pellets for auguring into the firebox for combustion. Although embodiments of the present disclosure are illustrated as having a front-feeding hopper system 106, it should be understood that certain embodiments will have a side-feeding system. The present disclosure is not intended to be limited by the arrangement of the hopper and related components but can be adapted for use with many pellet-based or solid fuel cooking devices as known in the art.

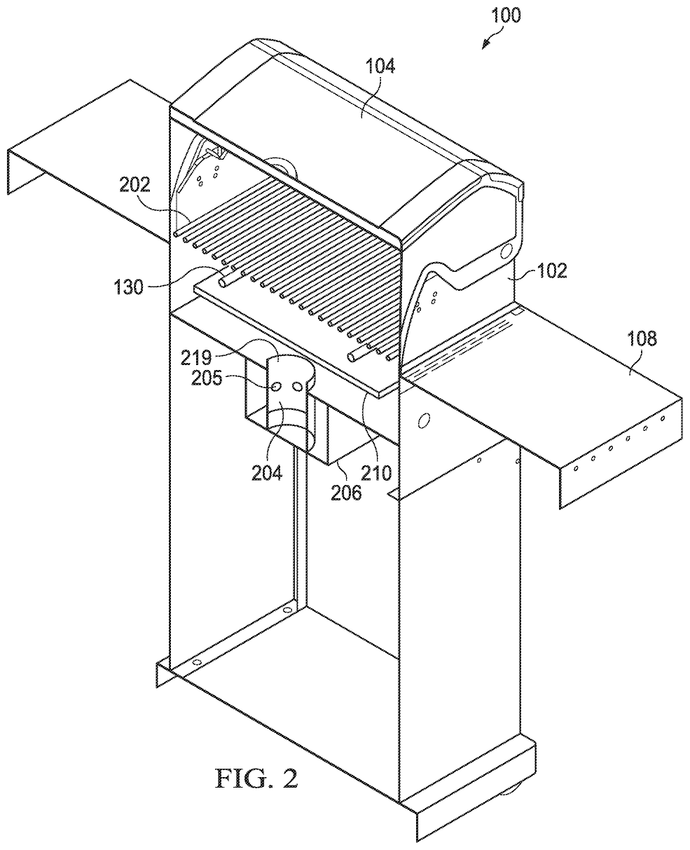

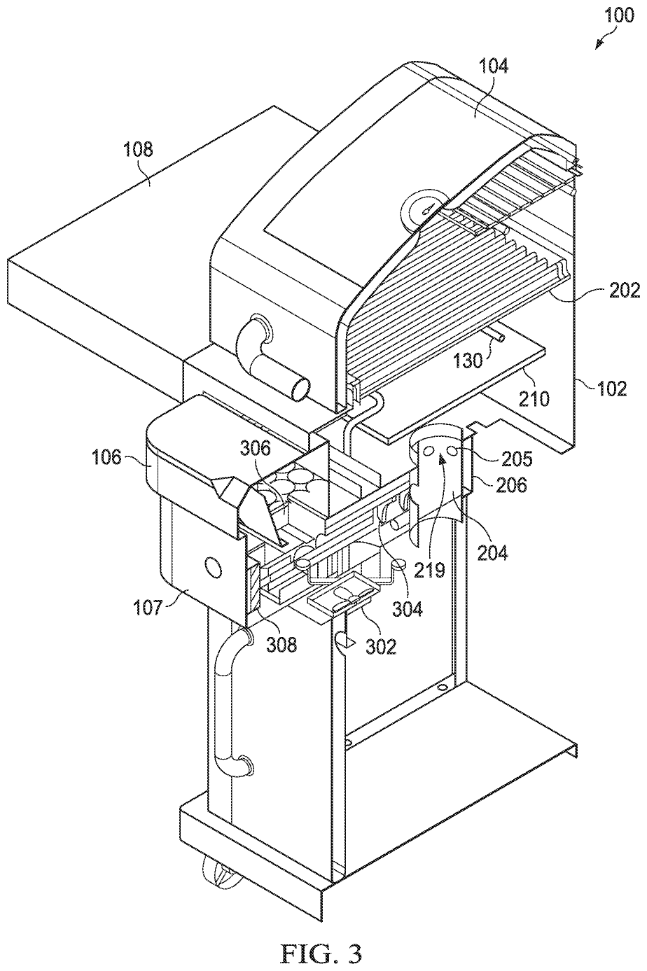

FIG. 2 is a front perspective cutaway view of the cooking grill of FIG. 1. FIG. 3 provides a complementary side perspective cutaway view. Here the interior of the firebox 102 can be seen, including a cooking grate 202 placed above a combustion chamber 204. In the present embodiment, the combustion chamber 204 comprises a firepot adapted to burn pelletized solid fuel. The combustion chamber 204 may have perforations or air openings 205 for receiving combustion air from a plenum 206. In some embodiments, plenum 206 is pressurized (e.g., by an electric fan 302 to drive air into the combustion chamber 204 to control or enhance the combustion of wood pellets or other fuel in the combustion chamber 204.

Fuel may be transported into the combustion chamber 204 by an auger 304 or other motive device from a refillable hopper 306. The auger 304 may be arranged to pass through the plenum 206 and may be powered by an electric motor 308 that is controlled by a user to adjust the heat and combustion within the firebox 102.

Heated combustion gases may flow from the combustion chamber 204 via exhaust or combustion opening 219. In some embodiments the opening 219 is round corresponding with an overall cylindrical shape of the combustion chamber 204. The combustion chamber 204 may produce smoke for cooking purposes and will produce some heat as well. The smoke and heat produced by the combustion chamber 204 may be controlled by the amount and timing of pelletized fuel introduced to the combustion chamber 204 by the auger 304.

A heating element 130 may also provide heat for cooking, with or without operation of the combustion chamber 204. However, in some modes of cooking, the combustion chamber 204 may be operated primarily to produce smoke for flavoring purposes while the heating element 130 is operated to ensure a desired cooking temperature. The heating element 130 may be below a cooking grate 202 in the firebox 102. The heating element 130 may be an electrically operated resistive heating element.

Both the auger and the heating element may be controlled or operated by a control panel 107 or other implements. In some embodiments, a user may have full control over auger speed and current applied to the heating element 130 such that smoke production and temperature may be controlled separately. In some embodiments, controls may be provided for selecting predetermined operation modes based on sequential and/or variable operation of the auger 304 and heating element 130 (e.g., startup, hi, med, low, etc.). The fan 302 may be operated as part of the control over the auger 304 and combustion chamber 204 and may operate at different speeds based on auger speed, cycle selected, and/or direct control by the user (e.g., via control panel 107). Circuitry, switch gear, controllers and the like necessary for operation of the auger 304, fan 302, heating element 130, and other operations of the grill 100 may be employed as known in the art.

A plate or baffle 210 may interpose the combustion chamber 204 and the heating element 130. The baffle 210 may comprise a flat or planar piece of material such as steel or another heat resistant material. The baffle 210 may be square, rectangular, or another shape. In some embodiments, it has a shape corresponding to the shape of the firebox 102. The baffle 210 may allow for a space between it and walls of firebox 102 on one side, multiple sides, or all sides. In this manner, the baffle 210 operates to disperse combustion products (e.g., smoke) from the combustion chamber to all sides and corners of the firebox as it rises to the cooking grate 202. In some embodiments, the baffle 210 may depart from a planar configuration and be shaped to as to direct heat and combustion gases in a variety of ways. In some cases, the baffle 210 is solid (unperforated) and in other cases one more holes or perforations (not shown) may be defined therein for additional passage of smoke and combustion gases from the combustion chamber 204.

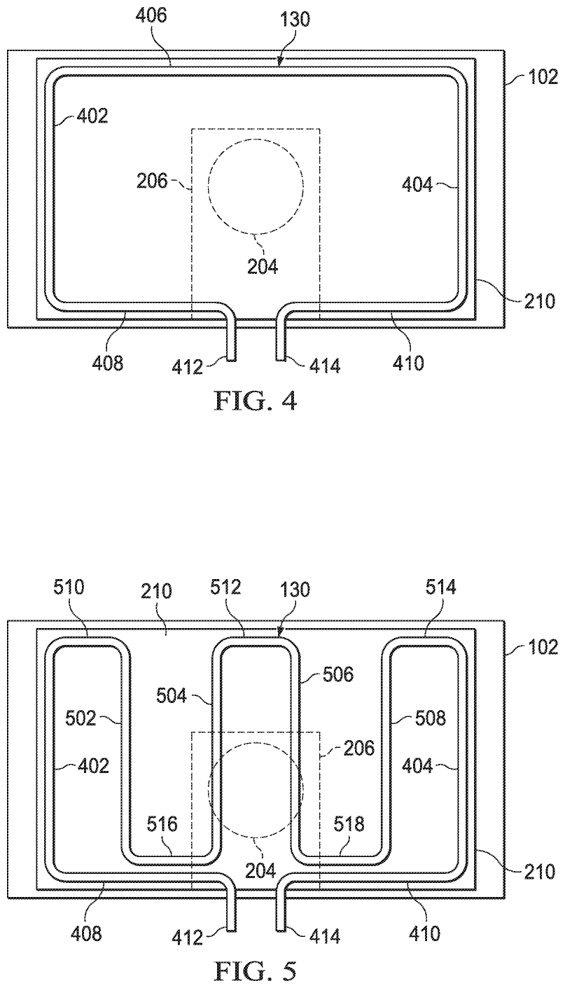

Referring now to FIG. 4 an overhead cutaway view of a firebox 102 of a pellet grill according to aspects of the present disclosure is shown. The heating element 130, as illustrated in FIG. 4, comprises a loop of resistive heating material such as Calrod® or similar. The heating element 130 may run near the edges of the firebox 102 and the baffle 210 so as to minimize effects from heat loss through the walls of the firebox 102. In the case of a firebox with a somewhat rectangular cross section, the heating element 130 may be arranged in rectangular loop. Here two opposed and parallel side segments 402, 404 of the heating element 130 can be seen near opposite sides of the firebox 102. A back segment 406 joins the side segments 402, 404 and is parallel and spaced apart from two frontal sub-segments 408, 410. The front sub-segments 408, 410 may provide for positive and negative terminals 412, 414, respectively of the heating element 130. In other embodiments, positive and negative terminals may be reversed. Some resistive heating elements do not require that polarity be observed.

Referring now to FIG. 5 an overhead cutaway perspective view of a firebox 102 of another pellet grill according to aspects of the present disclosure is shown. Here, the resistive heating element 130 is longer and has a greater number of segments than illustrated in FIG. 4, for example. Side segments 402, 402 remain as do front subsegments 408, 410. However, there are additional parallel segments 502, 504, 506, 508 spanning front-to-back. These are joined by back sub segments 510, 512, 514 and medial subsegments 516, 518 to complete a circuit over the baffle 210. In some embodiments, the side segments 402, 402 are parallel to segments 502, 504, 506, 508. The back subsegments 510, 512, 514 may be coaxial. Medial subsegments 516, 518 may be coaxial. Back subsegments 510, 512, 514 and medial subsegments 516, 518 may be parallel with front subsegments 408, 410. In other embodiments, there may be more or fewer parallel and/or coaxial segments but the configuration shown in FIG. 5 provides both adequate edge heating (e.g., to compensate for heat losses near the sides of firebox 102) as well as additional heating below all parts of the cooking grate 202 compared with the configuration of FIG. 4.

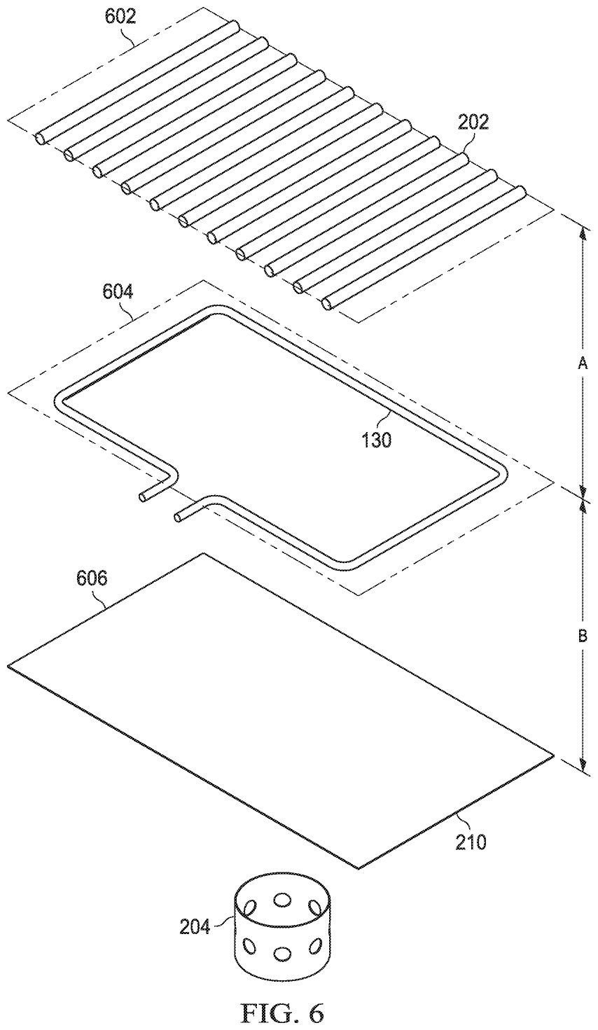

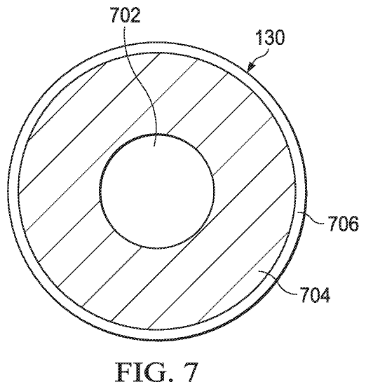

Referring now to FIG. 6 is an exploded perspective view of an interior of a firebox of a pellet grill according to aspects of the present disclosure. For illustrative purposes, only interior components are shown. It should be understood that various hardware such as brackets, clamps, braces, etc. as known in the art may be used to locate the cooking grate 202 within the firebox 102. Similarly, known implements may be used to properly locate the heating element and the baffle 210 with respect to one another, the cooking grate 202, and the firebox 102. The present disclosure is not intended to be limited to specific mounting and assembly hardware.

In FIG. 6 the cooking grate 202 may be seen to occupy a plane 602, while the heating element 130 occupies plane 604, and baffle occupies plane 606. For purposes of the present disclosure “occupying a plane” is taken to mean that the component occupying the plane is configured and situated such that the plane bifurcates the component from top to bottom. The component may not depart appreciably away from the plane on either side, as the cooking grate 202, the heating element 130, and the baffle 210 are relatively flat planar components to begin with.

When the grill 100 is assembled, plane 602 may be spaced apart from plane 604 a predetermined or fixed distance A, while plane 604 is spaced from plane 606 a predetermined or fixed distance B. Distance A and B may be, for example, 25 mm to 100 mm, 25 mm to 50 mm, or 50 mm or 100 mm, or another distance. Planes 602, 604, 606 and thus cooking grate 202, heating element 130, and baffle 210 may be parallel to one another. The distance A may be selected based upon the output of the radiant heating element 130 (e.g., the operating wattage). Whether the heating element appears as in FIG. 4 or FIG. 5 may also bear upon the distance A selected. In some cases, the distance A may be variable by a user (by movement of the cooking grate 202 or the heating element 130, for example).

Referring now to FIG. 7, a closeup cutaway view of a heating element 130 according to aspects of the present disclosure is shown. The heating element 130 may employ the joule heating phenomena. Heating element 130 may comprise one or more electrically resistive cores or heating wires 702 (which may helical wound members). An electric insulator 704, such as magnesium oxide, for example, may surround the resistive core 702. A casement 706 comprising stainless steel or another alloy, for example may provide an outer layer. The entire structure may be elongated and bent as shown in FIGS. 4-5, for example.

A household power supply typically provides 110/130 volts or 220/240 volts and may be used to drive the auger 304, ignitor 220, and fan 302 of pellet grill 100. Subtracting the power required to drive the auger 304, ignitor 220, and fan 302 (e.g., 200-300 w), the remaining power is available for use to power radiant heating element 130.

A pellet grill with supplementary radiant heating element 130 according to embodiments of the present disclosure is advantageous in at least two modes. In a first mode of long duration, low temperature cooking, utilizing the firepot or combustion chamber 204 typically using duty cycle control of the pellet feed system 106, the electric element 130 can be cycled to produce radiant heating as a supplement to the convective heating of the pellet system. The radiant heating element 130 may be constructed to provide supplemental heat in cooking areas of uneven heat (e.g., edge areas as discussed above).

In a second mode of short duration, high temperature cooking, with the combustion chamber 204 running at maximum pellet feed rate, the electric element 130 may be powered at a maximum power (for example 1400w for the typical United States household 120v, 1800w circuit). In this case, the radiant heating element 130 may be configured to provide the highest level of heat evenly across the cooking area (e.g., cooking grate 202).

In some constructions, the baffle 210 may or may not be in placed directly above the combustion chamber 204. For an appliance designed to do low intensity and high intensity heating in the same cooking session, the electric element 130 may be configured to provide the best overall performance in both the aforementioned modes. It will be also noted that the presence of the electric element 130 will significantly increase the relative amount of radiant heating provided to the food, leading to improved cooking characteristics, especially of meat.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking apparatus comprising:
a cooking chamber;
a cooking grate in the cooking chamber;
a combustion chamber within the cooking chamber below the cooking grate;
an electric heating element below the cooking grate; and
a baffle interposing the cooking grate and the combustion chamber.

2. The cooking apparatus of claim 1, wherein the electric heating element is a resistive heating element.

3. The cooking apparatus of claim 1, wherein the electric heating element interposes the baffle and the cooking grate.

4. The cooking apparatus of claim 3, wherein the electric heating element occupies a heating element plane that is parallel to a cooking grate plane occupied by the cooking grate.

5. The cooking apparatus of claim 4, wherein the baffle occupies a baffle pane that is parallel to the cooking grate plane.

6. The cooking apparatus of claim 5, wherein the electric heating element is about 25 mm to about 100 mm below the cooking grate.

7. The cooking apparatus of claim 5, wherein the combustion chamber comprises a cylindrical firepot configured to burn pelletized solid fuel.

8. The cooking apparatus of claim 3, wherein the electric heating element comprises a loop of resistive material.

9. The cooking apparatus of claim 3, wherein the electric heating element comprises a length of resistive material arranged to have a plurality of parallel segments.

10. The cooking apparatus of claim 9, wherein the length of resistive material is arranged to have at least four parallel segments.

11. The cooking apparatus of claim 1, wherein the electric heating element comprises a plurality of separately activatable resistive heating elements.

12. A cooking device comprising:
a cooking chamber;
a fuel pellet hopper outside the cooking chamber;
a cooking grate in the cooking chamber;
a perforated combustion chamber in the cooking chamber below the cooking grate;
an auger that transports fuel pellets from the hopper to the combustion chamber;
a plenum that delivers combustion air under positive pressure to an area surrounding the combustion chamber and into the combustion chamber;
a baffle plate above the combustion chamber;
an electric heating element between the baffle plate and the cooking grate.

13. The cooking device of claim 12, wherein:
the electric heating element comprises a current carrying metal alloy wire surrounded by an insulating material that is thermally conductive but not electrically conductive, and an outer metal alloy sheath heated by resistive heating of the current carrying metal alloy wire.

14. The cooking device of claim 13 wherein the electric heating element is configured in a loop located proximate walls that define a perimeter of said cooking chamber.

15. The cooking device of claim 13, wherein the electric heating element comprises a plurality of parallel segments.

16. The cooking device of claim 12, wherein the cooking grate, the electric heating element, and the baffle plate are arranged on parallel planes.

17. The cooking device of claim 16, wherein the heating element is from about 25 mm to about 100 mm away from the cooking grate.

18. A method comprising:
providing a firebox with a cooking grate therein;
providing a solid fuel burning combustion chamber below the cooking grate;
proving a baffle plate between the combustion chamber and the cooking grate that disperses combustion gases from the combustion chamber before the combustion gases reach the cooking grate; and
providing a resistive heating element above the baffle plate that provides additional heating to the cooking grate in addition to that from the combustion gases.

19. The method of claim 18, further comprising controlling combustion in the combustion chamber by controlled feeding of solid fuel pellets into the combustion chamber, and controlling heating from the resistive heating element by controlled application of electrical current thereto.

20. The method of claim 19, further comprising arranging the resistive heating element into a series of loops and parallel segments, each equidistant from the cooking grate.
